(19) United States
(12) Patent Application Publication
(10) Pub. No.: US 2006/0171068 A1
(43) Pub. Date: Aug. 3, 2006

(54) Perpendicular magnetic head and perpendicular magnetic disk apparatus

(75) Inventor: Tomoko Taguchi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/342,600

(22) Filed: Jan. 31, 2006

(30) Foreign Application Priority Data
Jan. 31, 2005 (JP) 2005-024484

(51) Int. Cl. G11B 5/127

(52) U.S. Cl. 360/125

(57) ABSTRACT

According to one embodiment, a perpendicular magnetic head has a write head including a main pole, a return yoke and a recording coil, a read head including a magnetoresistive film and a pair of shields arranged so as to sandwich the magnetoresistive film, and a soft magnetic film arranged so as to surround side faces and a top face of the read head.

### CROSS-REFERENCE TO RELATED APPLICATIONS

This application is based upon and claims the benefit of priority from prior Japanese Patent Application No. 2005-024484, filed Jan. 31, 2005, the entire contents of which are incorporated herein by reference.

### BACKGROUND

1. Field

One embodiment of the present invention relates to a perpendicular magnetic head and a perpendicular magnetic disk apparatus.

2. Description of the Related Art

In recent years, magnetic disk apparatuses have been severely required to have sufficient external magnetic field resistance in accordance with reduction in size and weight.

Conventionally, in order to improve the external field resistance of the magnetic disk apparatus, it has been proposed, for example, to provide a magnetic shield member surrounding the main pole of the write head by which an external magnetic field is prevented from penetrating into the main pole so as to reduce adverse effect of the external field (see Jpn. Pat. Appln. KOKAI Publication No. 2004-185672).

The present inventor has found that, when an external field intrudes into the magnetic head, a magnetic flux leaks from edge portions of the shields of the read head facing the magnetic disk, so that data already recorded to the magnetic disk may be miserased. Also, it has been found that the adverse effect of the external field through the shields of the read head is rather profound than that through the main pole. However, since the conventional magnetic disk apparatus has the magnetic shield member surrounding the main pole only, it cannot avoid the above problem and has an insufficient external field resistance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not limited the scope of the invention.

FIG. 1 is a perspective view showing a principal part of a perpendicular magnetic disk apparatus according to a first embodiment;

FIG. 2 is a front view of the perpendicular magnetic disk apparatus according to the first embodiment viewed from the head trailing side;

FIG. 3 is a bottom view of the magnetic head according to the first embodiment viewed from the air bearing surface;

FIG. 4 is a plan view showing a shape of another soft magnetic film used in the first embodiment;

FIG. 5 is a front view of a perpendicular magnetic disk apparatus according to a modified embodiment for the first embodiment viewed from the head trailing side;

FIG. 6 is a perspective view showing a principal part of a perpendicular magnetic disk apparatus according to a second embodiment;

FIG. 7 is a front view of the perpendicular magnetic disk apparatus according to the second embodiment viewed from the head trailing side;

FIG. 8 is a bottom view of the magnetic head according to the second embodiment viewed from the air bearing surface;

FIG. 9 is a front view of a perpendicular magnetic disk apparatus according to a third embodiment viewed from the head trailing side;

FIG. 10 is a front view of a perpendicular magnetic disk apparatus according to a modified embodiment for the third embodiment viewed from the head trailing side;

FIG. 11 is a front view of a perpendicular magnetic disk apparatus according to a fourth embodiment viewed from the head trailing side; and

FIG. 12 is a graph showing a relationship between s/p and permissible external field.

### DETAILED DESCRIPTION

Various embodiments according to the invention will be described hereinafter with reference to the accompanying drawings. In general, according to one embodiment of the present invention, there is provided a perpendicular magnetic head according comprising: a write head including a main pole, a return yoke, and a recording coil; a read head including a magnetoresistive film, and a pair of shields arranged so as to sandwich the magnetoresistive film; and a soft magnetic film arranged so as to surround side faces and a top face of the read head.

### First Embodiment

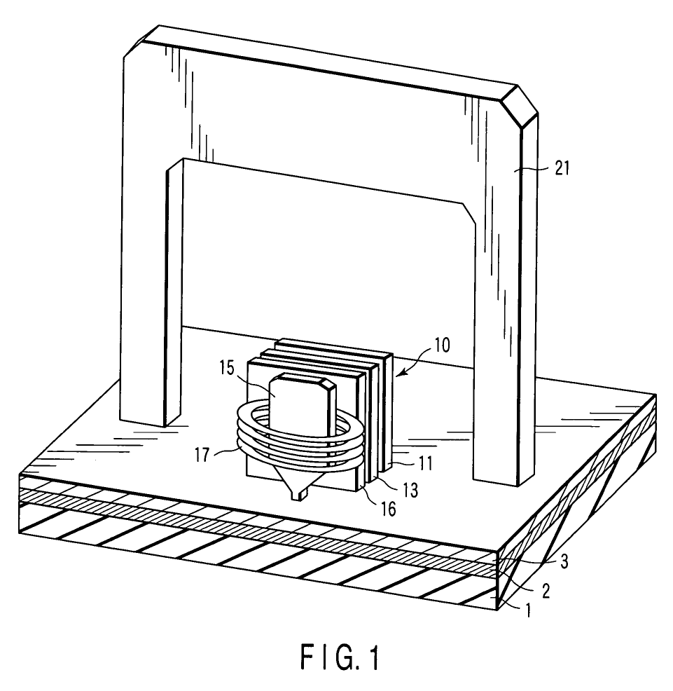

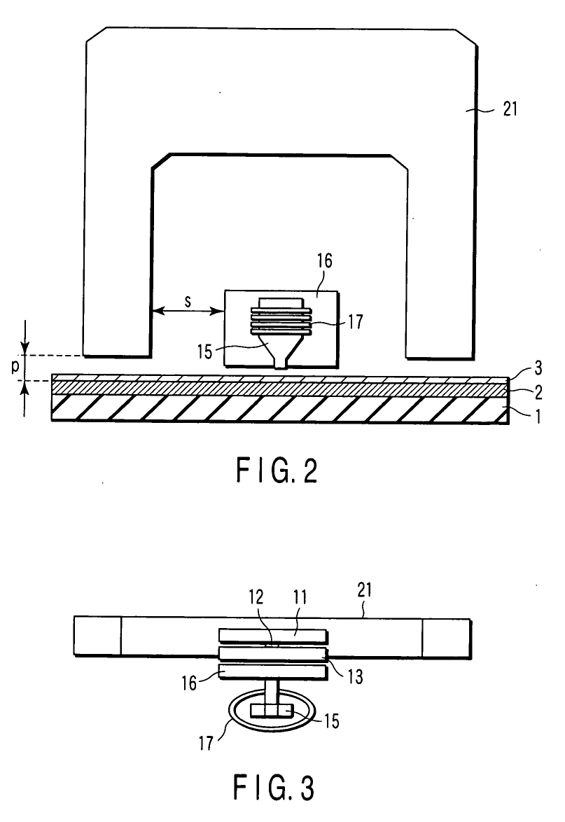

FIG. 1 is a perspective view showing a principal part of the perpendicular magnetic disk apparatus according to the first embodiment, FIG. 2 is a front view of the perpendicular magnetic disk apparatus viewed from the head trailing side, and FIG. 3 is a bottom view of the magnetic head viewed from the air bearing surface (ABS).

The magnetic disk (a so-called perpendicular double-layer media) mounted to the perpendicular magnetic disk apparatus has a structure that the soft magnetic underlayer 2 and the perpendicular recording layer 3 are formed on the substrate 1. The perpendicular recording layer 3 has magnetic anisotropy in the perpendicular direction to the media surface.

The magnetic head 10 installed in the perpendicular magnetic disk apparatus has a read head and a write head. The read head has a structure that the magnetoresistive film (GMR film) 12 is sandwiched between the shields 11 and 13 formed of a soft magnetic material. The write head includes the main pole 15, the return yoke 16 that is provided on the leading side with respect to the main pole 15, and the recording coil 17. Further, the soft magnetic film 21 is provided so as to surround the side faces and the top face (the face remote from the ABS) of the read head. The bottom surfaces of the soft magnetic film 21 are arranged up to the vicinity of the magnetic disk. The soft magnetic film 21 can be easily formed as a pattern of a soft magnetic film on the end surface of the head slider (not shown).

Thus, the soft magnetic film 21 surrounds the side faces and the top face of the read head except the ABS and exerts a function of shielding the entire read head against an external field, making it possible to prevent the external field from intruding into the read head.

Further, the apparatus is designed such that the distance s between the soft magnetic film 21 and the shields 11 and 13 in the read head is made greater than the distance p between the soft magnetic film 21 and the soft magnetic underlayer 2 in the magnetic disk. Here, the distance s between the soft magnetic film 21 and the shields 11 and 13 in the read head means the smallest distance therebetween. For the present embodiment, the distance s is the distance between the inner side face of the soft magnetic film 21 and the sides of the shields 11 and 13. In such a design, because the external field is made to flow from the soft magnetic film 21 to the soft magnetic underlayer 2 in the magnetic disk, there is no case where the external field reaches the shields 11 and 13 through the soft magnetic film 21. Accordingly, miserase of recorded data by the leakage magnetic fluxes from the edge portions of the shields 11 and 13 in the read head due to the intrusion of the external field can be prevented. Likewise, misread of read signals can be prevented.

Here, it is preferable that the ratio s/p between the distance s and the distance p satisfy the following relationship: 1<s/p≦50. Because the distance s between the soft magnetic film and the shields included in the read head should be greater than the distance p between the soft magnetic film and the soft magnetic underlayer of the magnetic disk, s/p is greater than 1. However, if the distance s is too large, the external field resistance is degraded. FIG. 12 shows a relationship between s/p and permissible external field based on experiments. The following empirical formula is given from the graph:

Permissible external field=250×exp(−s/50 p).

Provided that the external field resistance required in the market is 100 Oe, the ratio s/p should preferably be 50 or less.

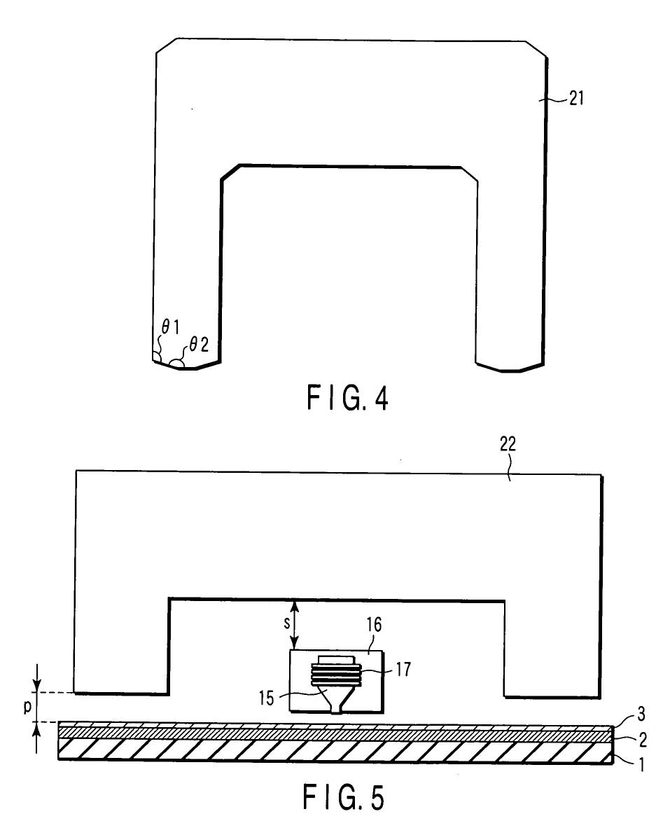

In the present embodiment, it is preferable that obtuse-angled portions (for example, θ1 and θ2 in FIG. 4) are provided by beveling the edge portions on the ABS of the soft magnetic film 21 as shown in FIG. 4. When the edge portions of the soft magnetic film 21 are processed in such a manner, concentration of the external field can be suppressed, and thus magnetic fluxes are allowed to flow smoothly from the soft magnetic film 21 to the soft magnetic underlayer 2.

It should be noted that the shape of the soft magnetic film shielding the entire read head is not particularly limited. For example, the soft magnetic film 22 having the shape shown in FIG. 5 can be used. In FIG. 5, the smallest distance s between the soft magnetic film 22 and the shields 11 and 13 is the read head is the distance between the bottom face of the upper portion of the soft magnetic film 22 and the top face of the shields 11 and 13.

### Second Embodiment

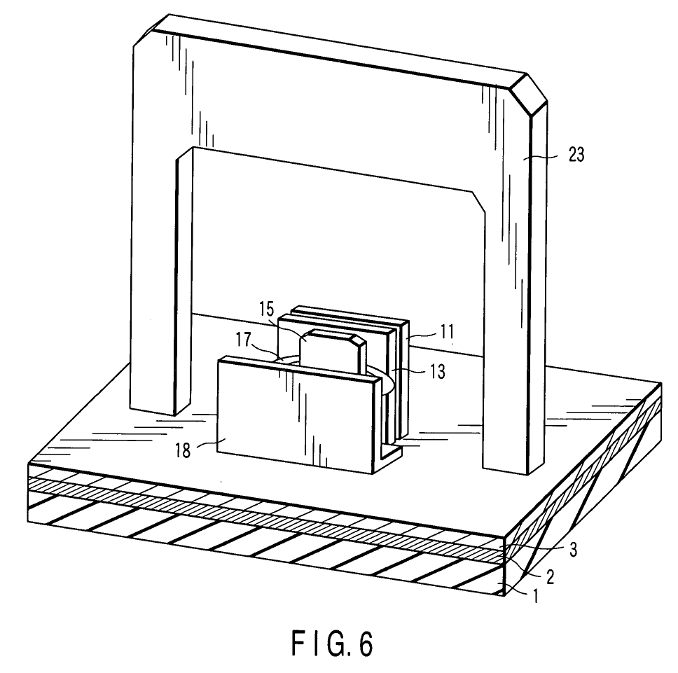

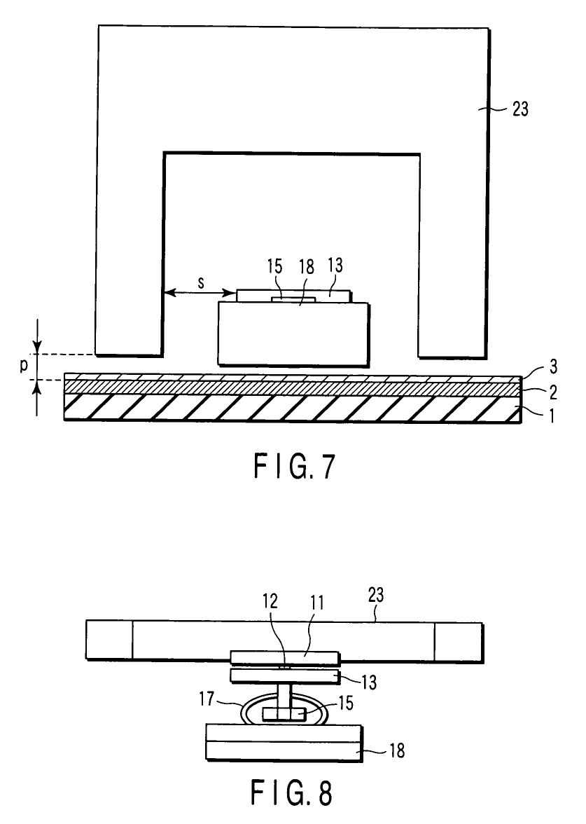

FIG. 6 is a perspective view showing a principal part of the perpendicular magnetic disk apparatus according to the second embodiment, FIG. 7 is a front view of the perpendicular magnetic disk apparatus viewed from the head trailing side, and FIG. 8 is a bottom view of the magnetic head viewed from the ABS.

The perpendicular double-layer media mounted to the perpendicular magnetic disk apparatus has the similar structure to that shown in FIGS. 1 and 2. The magnetic head installed in the perpendicular magnetic disk apparatus has a read head and a write head. The read head has a structure that the GMR film 12 is sandwiched between the shields 11 and 13 formed of a soft magnetic material. The write head includes the main pole 15, the return yoke 18 that is provided on the trailing side with respect to the main pole 15, and a recording coil 17. Further, the soft magnetic film 23 is provided so as to surround the side faces and the top face of the read head. The bottom surfaces of the soft magnetic film 23 are arranged up to the vicinity of the magnetic disk. Thus, the soft magnetic film 23 surrounds the side faces and the top face of the read head except the ABS and exerts a function of shielding the entire read head against an external field, making it possible to prevent the external field from intruding into the read head.

Also, the apparatus is designed such that the distance s between the soft magnetic film 23 and the shields 11 and 13 in the read head is made greater than the distance p between the soft magnetic film 23 and the soft magnetic underlayer 2 in the magnetic disk. In the present embodiment as well, because the external field is made to flow from the soft magnetic film 23 to the soft magnetic underlayer 2 in the magnetic disk, there are no case where the external field reaches the shields 11 and 13 through the soft magnetic film 23. Accordingly, miserase of recorded data and misread of read signals can be prevented.

In the present embodiment as well, it is preferable that obtuse-angled portions are provided by beveling the edge portions on the ABS of the soft magnetic film 23, in the same way as in FIG. 4.

### Third Embodiment

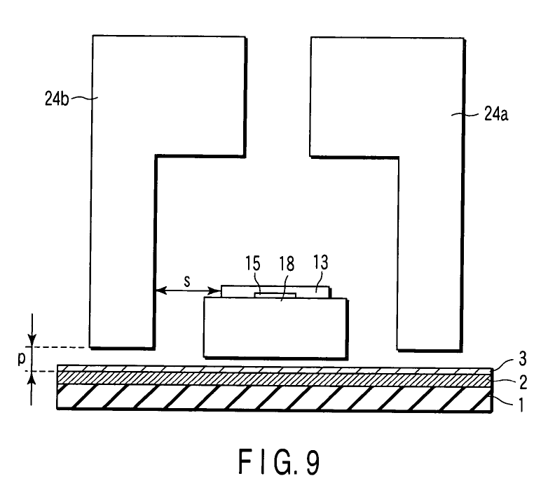

FIG. 9 is a front view of the perpendicular magnetic disk apparatus according to the third embodiment viewed from the head trailing side.

The perpendicular double-layer media, the read head, and the write head in this perpendicular magnetic disk apparatus have the similar structures to those shown in FIGS. 6 and 8. In the present embodiment, the soft magnetic films 24a and 24b divided into two parts are provided so as to surround the side faces and the top face of the read head. The bottom surfaces of the soft magnetic films 24a and 24b are arranged up to the vicinity of the magnetic disk. Further, the apparatus is designed such that the distance s between the soft magnetic films 24a and 24b and the shields 11 and 13 in the read head is made greater than the distance p between the soft magnetic films 24a and 24b and the soft magnetic underlayer 2 in the magnetic disk. In this way, even when the soft magnetic films 24a and 24b divided into two parts are provided, the external field can be prevented from intruding into the read head, and thus miserase of recorded data and misread of read signals can be prevented.

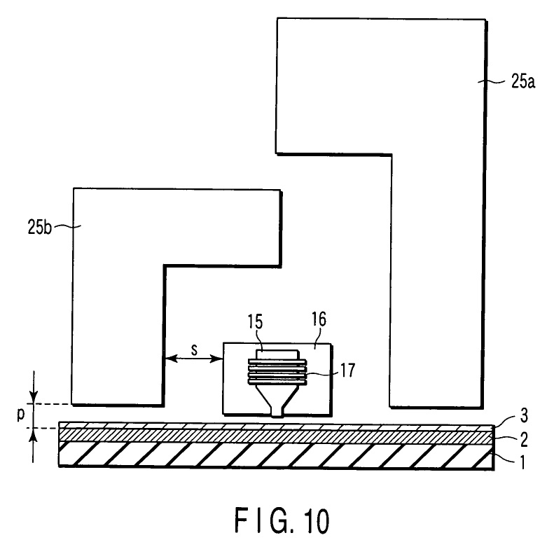

FIG. 10 shows a modified embodiment for FIG. 9. In the embodiment of FIG. 10, the soft magnetic films 25a and 25b divided into two parts are formed, and these soft magnetic films 25a and 25b have shapes, heights and areas different from each other. In this case, the soft magnetic film 25a with a larger area is formed in a region where an external field easily intrudes. In this case as well, the same effect as that of FIG. 9 can be obtained.

Also in the present embodiment, it is preferable that obtuse-angled portions are provided by beveling the edge portions on the ABS of the soft magnetic films, in the same way as in FIG. 4.

### Fourth Embodiment

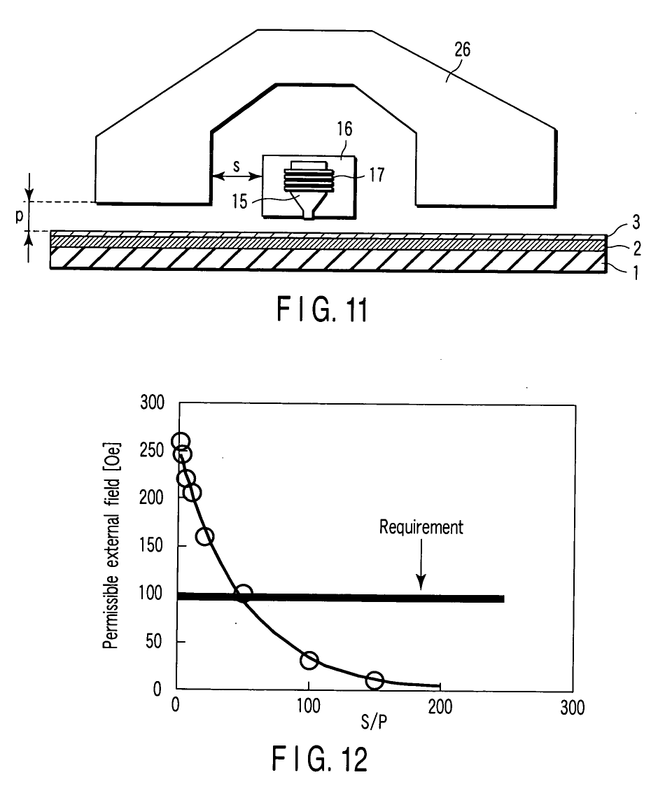

FIG. 11 is a front view of the perpendicular magnetic disk apparatus according to the fourth embodiment viewed from the head trailing side.

The perpendicular double-layer media, the read head, and the write head in this perpendicular magnetic disk apparatus have the similar structures to those shown in FIGS. 1 to 3. In the present embodiment, the cap-shaped soft magnetic film 26 is formed so as to surround the side faces and the top face of the read head. The bottom surfaces of the soft magnetic film 26 are arranged up to the vicinity of the magnetic disk. Further, the apparatus is designed such that the distance s between the soft magnetic film 26 and the shields 11 and 13 in the read head is made greater than the distance p between the soft magnetic film 26 and the soft magnetic underlayer 2 in the magnetic disk. In the present embodiment as well, the external field can be prevented from intruding into the read head, and thus miserase of recorded data and misread of read signals can be prevented. Further, because the soft magnetic film 26 is cap-shaped, magnetic fluxes can be prevented from being concentrated.

Also in the present embodiment, it is preferable that obtuse-angled portions are provided by beveling the edge portions on the ABS of the soft magnetic film 26, in the same way as in FIG. 4.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic head comprising:
a write head including a main pole, a return yoke, and a recording coil;
a read head including a magnetoresistive film, and a pair of shields arranged so as to sandwich the magnetoresistive film; and
a soft magnetic film arranged so as to surround side faces and a top face of the read head.

2. The perpendicular magnetic head according to claim 1, wherein the soft magnetic film is divided into a plurality of parts.

3. The perpendicular magnetic head according to claim 2, wherein the parts of the divided soft magnetic film have areas different from one another.

4. A perpendicular magnetic disk apparatus comprising:
a perpendicular magnetic head comprising: a write head including a main pole, a return yoke, and a recording coil; a read head including a magnetoresistive film, and a pair of shields arranged so as to sandwich the magnetoresistive film; and a soft magnetic film arranged so as to surround side faces and a top face of the read head; and
a magnetic disk including a substrate, and a soft magnetic underlayer and a perpendicular recording layer formed on the substrate.

5. The apparatus according to claim 4, wherein a distance s between the soft magnetic film and the shields included in the read head is greater than a distance p between the soft magnetic film and the soft magnetic underlayer in the magnetic disk.

6. The apparatus according to claim 5, wherein a ratio s/p between the distance s and the distance p satisfies the following relationship: 1<s/p≦50.

7. The apparatus according to claim 4, wherein portions of the soft magnetic film facing the magnetic disk are beveled.

8. The apparatus according to claim 4, wherein the soft magnetic film is divided into a plurality of parts.

9. The apparatus according to claim 8, wherein the parts of the divided soft magnetic film have areas different from one another.
